(19) United States
(12) Patent Application Publication
(10) Pub. No.: US 2008/0220117 A1
(43) Pub. Date: Sep. 11, 2008

(54) Injection Moulding Device

(75) Inventor: Herbert Gunther, Allendorf (DE)

Correspondence Address: CLARK & BRODY, 1090 VERMONT AVENUE, NW, SUITE 250, WASHINGTON, DC, 20005, US

(73) Assignee: GÜNTHER HEISSKANALTECHNIK GMBH, Frankenberg (DE)

(21) Appl. No.: 11/883,832

(22) PCT Filed: Feb. 7, 2006
(86) PCT No.: PCT/EP06/01080

§ 371 Date: Aug. 7, 2007

(30) Foreign Application Priority Data
Feb. 8, 2005 (DE) 20 2005 002 043.5

(51) Int. Cl. B29C 45/20

(52) U.S. Cl. 425/570

(57) ABSTRACT

An injection molding apparatus (10) comprises at least one manifold and at least one injection molding nozzle (30), each nozzle (30) being affixable by means of a fastener (40) to the manifold (20). To allow rapid assembly and durable sealing of all nozzles at the manifold, the fastener (40) is fitted with at least one centering and/or fixating element (50) which is supported in longitudinally displaceable manner and which in its final-assembly position is engageable to the manifold (20) in a manner that said manifold and the nozzle (30) are secured into their relative position. The fastener (40) comprises at least one recess (41) receiving the nozzle (30) and at least one further recess (42) to receive the fixating element (50) which is supported in longitudinally displaceable manner in said further recess (42). Preferably the fixating element (50) is a fastening element for the fastener (40), in particular it is a part of a bolt connection (14).

The present invention relates to injection molding apparatus.

Injection molding apparatus are known in numerous embodiment modes. Illustratively they are used as a hot or cold runner systems to feed a fluid plastic at a predetermined temperature and at high pressure to a separable mold block (mold cavity). Mostly temperature controlled nozzles are mounted for that purpose on a manifold system which also is temperature controlled and meter the material to be processed through a flow conduit into the mold cavity.

Typically each nozzle is fitted at its end facing the manifold with a flange-like or stepped connection head resting by a planar sealing surface against a flat end or side face of the manifold (German patent document 1 201 00 840 U1). The clamping force required to affix the nozzle illustratively is provided by tightening bolts screwed through boreholes fitted into the rim side of the connection head into the manifold. On the other hand the European patent document 0 732 185 B1 discloses bolt-passing boreholes in the manifold. The screws inserted therein engage a clamping ring on the other side across the nozzle connection head and clamp it hard against the manifold. An additional sealing ring may be used in the region of the central inlet of the flow conduit in the nozzle body aperture.

The above designs incur the drawback that when the apparatus is heated, the manifold also being heated by thermal expansion being displaceable away from the nozzles, that is, in spite of high clamping forces between the nozzle and the manifold, the sealing surfaces of the nozzles on one hand and the end of side faces of their manifold on the other, a sliding displacement takes place between them and consequently the manifold outlets and the nozzle intakes may shift relative to each other. If however said intakes and outlets no longer are all aligned, flow conditions will be degraded. Moreover said nozzles tilt on account of the transverse loads they experience, and leakages may ensue.

In order to preclude slippage between the manifold and the retention ring, the European patent document EP 0 732 185 B1 employs a system of alignment pins. This system comprises several alignment pins made to engage in geometrically locking manner the manifold and the retention ring. While such a configuration preserves positional alignment, it does on the other hand substantially make assembly more complex, in particular in the presence of a large number of nozzles. Moreover the European patent document EP 0 732 185 B1 requires that sideways shift between manifold and nozzle shall be possible any time.

The objective of the present invention is to avert those and further drawbacks of the state of the art and to create injection molding apparatus allowing both simple and rapid assembly of all nozzles to one manifold and assuring lastingly sealing all nozzles relative to the manifold. In particular the present invention strives to preclude shifting between manifold and nozzle following their assembly. Simple design is desired furthermore, remaining simple even in the presence of a plurality of nozzles. All of the apparatus shall be economical to build.

Claim 1 discloses the features of the present invention. Claims 2 through 29 define illustrative embodiments of the present invention.

Claim 1 of the present invention relates to injection molding apparatus comprising at least one manifold and at least on injection molding nozzle, each nozzle being affixed by a fastener to the manifold and said fastener comprising a centering and/or fixating element supported in longitudinally displaceable manner and in its end position being engaged to the manifold in a manner that the positions of the manifold and of the nozzle shall be fixed relative to each other.

By keeping their relative position constant, the present invention assures that the manifold no longer is able to move past the nozzles. These nozzles are always fixed in position even if the manifold on account of its thermal expansion should slightly shift. The centering/fixating elements keep the manifold outlets and the nozzles intakes always congruently one above the other and therefore can no longer shift relative to one another. The material to be processed may enter the nozzles unhampered.

The assembly disclosed above is as simple as it is economical because the longitudinally fixating elements initially are able to withdraw behind the particular fastener or be situated flush with it, as a result of which and in conventional manner, the nozzles may be assembled and thereupon the manifold may be deposited. Extant seats or pins can be neglected (if it were otherwise, large numbers of nozzles would prove overwhelming). Once the manifold has been deposited, all nozzles can be sequentially aligned rapidly and sequentially because all the longitudinally displaceable fixating elements can be made to sequentially engage the manifold. Cost in time and labor is minimal. Even when the manifold is thermally expanding, all its nozzles remain always firmly in a fixed position.

According to claim 2 the fastener is fitted with at least one recess to receive the nozzle. Preferably using a widened connection head, said nozzle is always securely held in place, as a result of which the fastener may generate a uniform pressure.

According to claim 3, the fastener comprises at least one additional recess in the fixating element, which, according to claim 4 is displaceably supported in the further recess. As a result the fixating element shall always be guided accurately. At the same time it is directly linked to the fastener, contributing in this way to accurate positional fixation and adjustment. The fixating element therefore also acts as centering element and appropriately, according to claim 5, it is configured/aligned parallel to the nozzle's longitudinal axis. In the design of claim 6, the fixating element may be made to engage the manifold so as to mechanically interlock with it.

To prevent the fixating element from dropping out during handling of and/or assembly of the apparatus of the present invention, said element is connected in loss-proof manner to the fastener as defined in claim 7. For that purpose, the design claimed in claim 8 illustratively limits the fixating element's longitudinal excursion, claim 9 providing as a first step a first fixating element stop constituted on the fastener's lower side. Said first stop at the same time also transmits the retention forces on the nozzle. According to claim 10 the fastener moreover comprises a protrusion, a hook or the like which constitutes a second stop. Within limits, the fixating element is prevented from easily slipping beyond said second stop.

According to claim 11, it is important that the spacing between the fastener's top side and the second stop be larger than the length of the fixating element. As a result said element is always able to withdraw behind the preferably planar top side of the fastener. In this manner the manifold may be deposited in unencumbered manner on the nozzles.

The design of claim 12 provides that, perpendicularly to the longitudinal axis and perpendicularly to the nozzle width, the fastener thickness shall be less than or equal to said nozzles' thickness perpendicularly to the longitudinal axis or perpendicularly to the nozzle width. In this manner the fastener shall present no obstacle when the largest possible number of (flat) nozzles should be configured sequentially at narrow cavity separations. The fasteners fit in problem-free manner into the manifold-nozzle system and ensure permanently accurate positions of all nozzles.

Claim 13 defines a further embodiment of considerable significance whereby the fixating element is or constitutes an affixation element of the fastener. In this manner and using only simple means and few components, the total design may be made compact, especially when according to claim 14, the fixating element is part of a bolt connection which, according to claim 15, runs through the manifold parallel to the nozzle longitudinal axis.

As claimed in claim 16, the bolt connection defined in it appropriately contains at least one bolt which may engage the fixating element. In order that the fixating element shall rotate along as the bolt is being screwed in, the fixation element of claim 17 is irrotationally supported relative to the fastener. In completion or alternatively hereto, and according to claim 18, the said bolt connection may comprise at least one bolt which may be made to directly engage the fastener.

In another design defined in claim 19, the fixating element is a bush and comprises a cylindrical shell and a flanged rim at one end. When the fixating element is engaged by the bolt and thereby is tightened, the bush rests by its flanged rim against the first fastener stop. Said fixating element then will be firmly clamped against the manifold. To enable the bolt to engage the bush, an inside thread is provided inside the shell as claimed in claim 20.

The flanged rim comprises two laterally flattened, keyed surfaces running parallel to one another (claim 21) to allow inserting the fixating element into the fastener, i.e. into its recesses. When said keyed surfaces are turned aside, the centering bush may be slipped past the second stop and be inserted into the further fastener recess. If on the other hand the fixating element is rotated by 90°, the flanged rim rests on the second stop. The fixating element no longer may slip out of the fastener. Simultaneously the fixating element is withdrawn behind the fastener, as a result of which the manifold may be deposited in unhampered manner on the nozzles.

In the further embodiment mode defined in claim 22, at least two fixating elements are used, this feature advantageously affecting the distribution of forces. A contribution is made further by the features of claim 23, for instance by configuring the fixating elements symmetrically to the nozzle axis. However and as defined in claim 24, if needed, the fixating elements also may be configured triangularly or circularly about the nozzle's longitudinal axis.

According to claim 25, the fastener may receive a minimum of two nozzles, so that the number of sprue points may be increased further. In this respect and according to claim 26, the nozzles are fitted with a common heating element.

Using the feature of claim 27, the nozzle compression exerted on the manifold may be increased if every nozzle within the fastener's recess is spring loaded.

Claim 28 defines a further embodiment of the present invention whereby the nozzle, the fastener and the fixating elements constitute a pre-assembled or pre-assemblable unit. The nozzles are factory delivered already joined to the fastener and to the fixating elements and may be installed directly. Logistics and storage are much eased thereby.

According to claim 29, the nozzle and the fastener are advantageously integral depending on the embodiment mode.

Further features, particulars and advantages of the present invention are contained in the claims and in the description of illustrative embodiment modes below and in relation to the appended drawings.

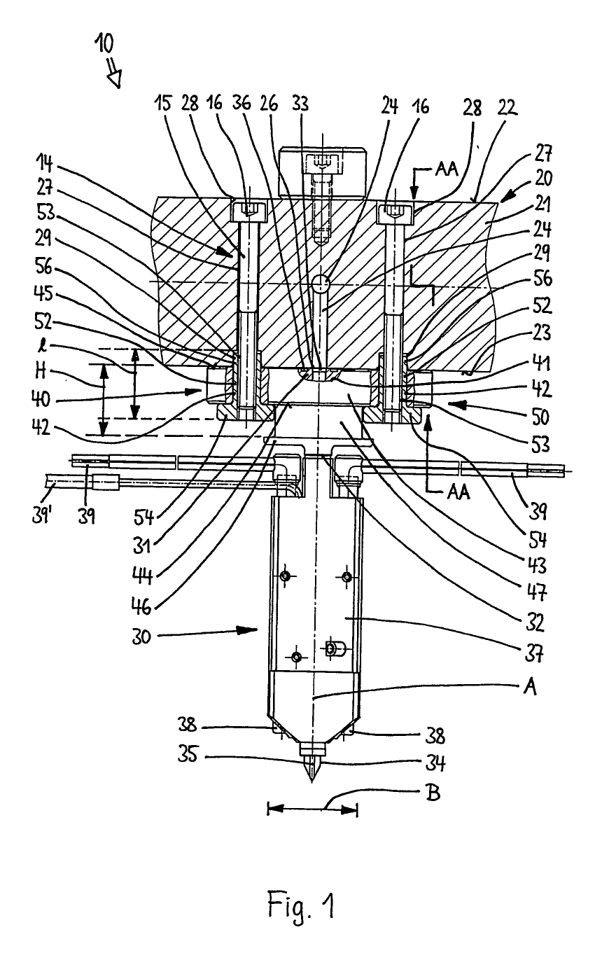

FIG. 1 is a schematic and partial sectional view of an injection molding apparatus,

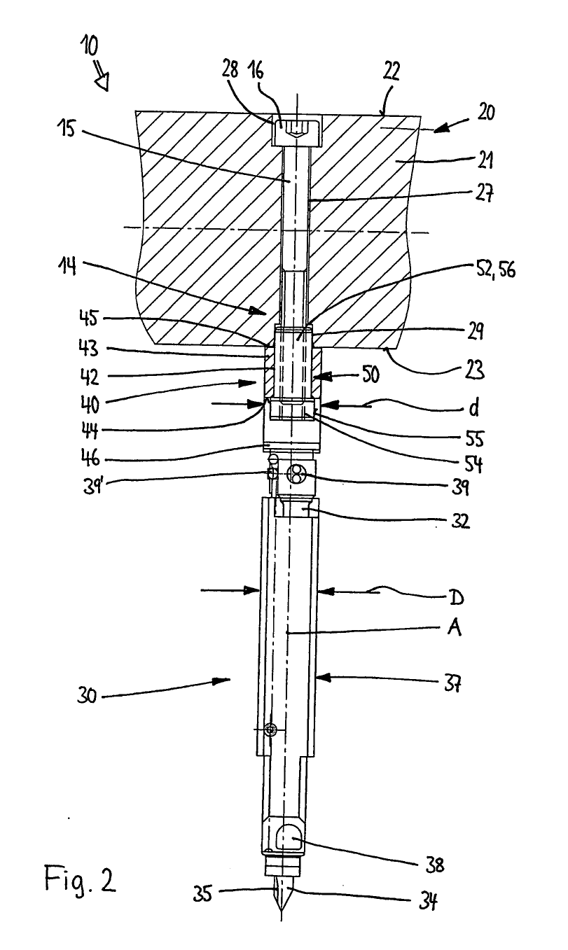

FIG. 2 is an elevation of the injection molding apparatus of FIG. 1 partly in section and along line AA,

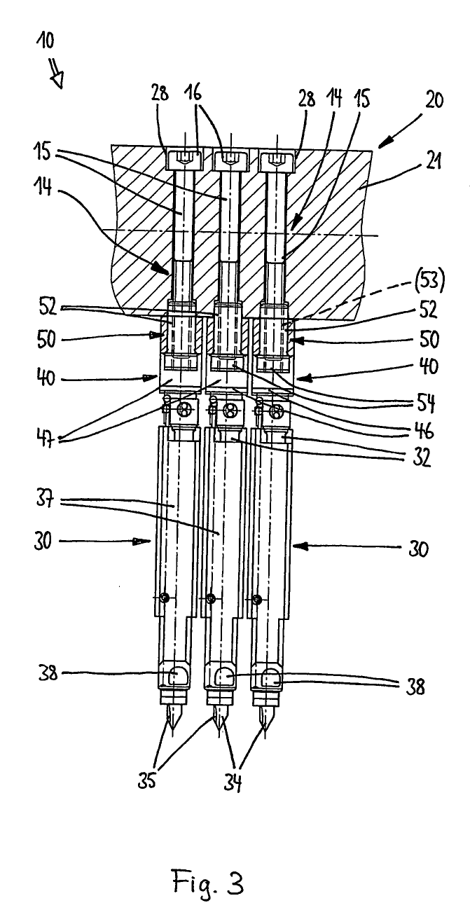

FIG. 3 is another illustrative embodiment mode of an injection molding apparatus, and

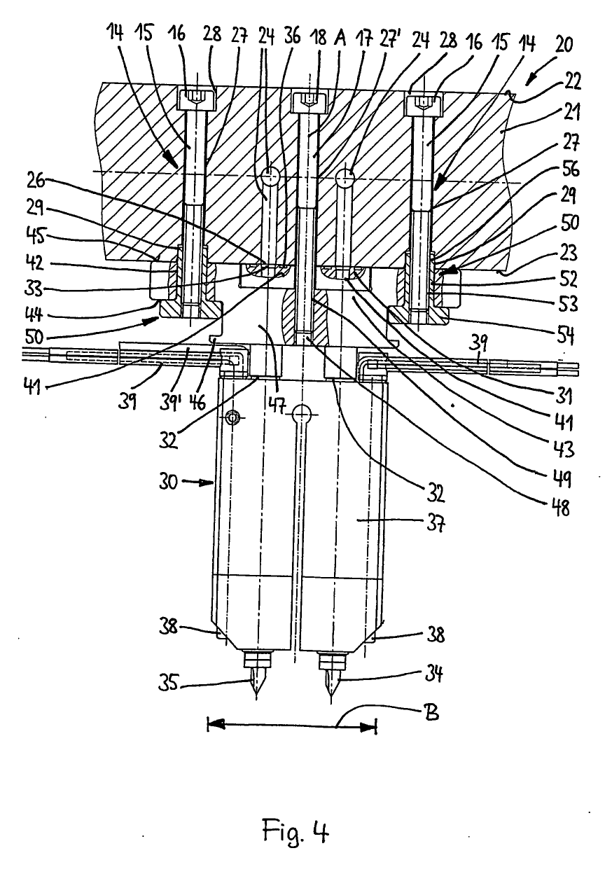

FIG. 4 is a further embodiment mode of an injection molding apparatus.

The injection molding apparatus overall denoted by 10 is used to process a melt of working material, for instance a plastic melt. Said injection molding apparatus comprises, besides other (omitted) components, for instance a feed system for the material to be processed, or a mold cavity plate with mold inserts and the like, a temperature controlled manifold 20, and, mounted to latter at least one hot runner nozzle 30, each hot runner nozzle 30 being affixable by a fastener 40 to the manifold 20.

The manifold 20 is constituted by a manifold plate 21 comprising a substantially upper planar side 22 and parallel thereto a substantially planar lower side 23. Several flow ducts 24 are integrated into the plate 21 and issue into outlet apertures 26 in the lower side 23 of the plate 21. Two continuous boreholes 27 are configured symmetrically with each outlet aperture 24 and are provided at the top side 22 of the plate 21 with a stepped recess 28 and at the lower side 23 of the plate 21 with a seat 29 also diametrically enlarged.

The hot runner nozzle 30 comprises a nozzle body (not referenced) having a flattened connection head 31 and a narrower tube 32 adjoining it below. The thickness (not referenced) of the connection head 31 transversely to the longitudinal axis A and across the width B of the nozzle 30 is only slightly larger than the diameter of the tube 32, as a result of which the nozzle body may be kept narrow as a whole. A flow duct (not visible) is centrally configured within the nozzle body and comprises a work material intake 33 in the connection head 31 and issues at its lower end into a nozzle tip 34 guiding the working material melt via at least one working material outlet 35 into the mold cavity. A sealing ring 36 to seal the hot runner nozzle 30 relative to the manifold 20 is configured concentrically with the working material intake 33 in the nozzle body's connection head 31.

A heater 37 in the form of a flat, solid element running almost over the full axial length is deposited on the outer circumference of the nozzle tube 32. A first (omitted) receiving channel in the form of a continuous borehole is integrated within the preferably highly thermally conducting solid element. The inside diameter of said receiving channel is slightly less than the outside diameter of the tube 32, as a result of which this shell always shall be interlockingly enclosed by the heater 37 to assure good heat transfer from the heater 37. The thickness D of the heater 37 transversely to the longitudinal axis A and across the width B of the nozzle 30 is slightly larger than the thickness of the laterally flattened connection head 31. In this manner the hot runner nozzle 30 together with the heater 37 is very flat.

Two further (not referenced) receiving channels are present in the heater block 37 parallel to the first channel. The contain two elongated heating elements 38 that run almost the full axial length of the heater 37. Electrical hookups 39 extending from the heater 37 connect the heating elements 38 to an omitted control circuit. The outside diameter of each heating element 38 is slightly larger than the inside diameter of the receiving channels which are preferably open at the top and at the bottom, whereby the heating elements are enclosed by, and always make good thermal contact with, the thermally well conducting solid block 37. The heat generated by the heater elements 39 is always optimally transferred to the solid block 37 and from same to the nozzle body 31, 32.

An additional pickup channel (not visible) receiving an omitted temperature sensor is configured in the immediate vicinity of the nozzle tube 32 to detect the temperature created by the heater 37. Again the terminals 39′ of said sensor may run laterally away from the heater 37 and be connected to the control circuit.

The fastener 40 clamps the hot runner nozzle 30 in the longitudinal direction A against the lower side 23 of the manifold 20. For that purpose said fastener is designed with a barrel-like main part 43 comprising a central recess 41 to receive the connection head 31 and to pass the nozzle tube 32. Two bolt segments 14 guided in the continuous boreholes 27 of the manifold 20 engage from behind the barrel 43 which thereby is pulled uniformly and the connection head 31 of the nozzle 30 thereby can be forced in sealing manner against the manifold underside 23.

It follows from FIG. 1 that the barrel 43 on the whole is wider than the connection head 31 or the nozzle 30. However, as shown in FIG. 2, the thickness d of the main part 43 perpendicularly to the longitudinal axis A is not larger than the thickness D of the heater 37, i.e. of the nozzle 30, whereby the horizontal dimensions relating to integrating the nozzle 30 are only insignificantly changed by the fastener 40. As shown by FIG. 3, the hot runner nozzles may be configured in sequence and at minimal spacings, whereby several mold cavities or several gate points may be injected simultaneously. The cavity separations or the gate separations may be selected being minute in at least one direction perpendicular to the axial direction A.

To secure the hot runner nozzle 30 not only axially, but also laterally, two centering, i.e. fixating elements 50 symmetrical to the nozzle axis are used in the fastener 40 and, being in the form of components of the bolt connections 14, are supported longitudinally and, in their final, assembled position, may be made to made to engage in interlocking manner the seats 29 in the manifold 20 whereby the nozzle 30 is fixed in position relative to the manifold 20.

Each fixating element 50 is designed in the form of an elongated bush comprising a cylindrical shank 52 and a terminal, flanged rim 54. The shank 52 is guided with little play in a further recess 42 in the barrel-like main part 43 parallel to the longitudinal axis A of the nozzle 30 and comprises an inside thread 53 engaged by a bolt 15 of the bolt connection 14.

Whereas each bolt 15 rests by a head 16 in the recess 28 of the continuous borehole 27 in the manifold 20, the flanged rim 54 of the centering bush 50 does rest against the preferably planar underside 44 of the barrel 43. At the same time the fixating elements 50, which are supported in longitudinally displaceable manner in the recesses 42 by their shell ends 56 engage in mechanically interlocking manner the seats 29 in the manifold 20.

Accordingly the fastener 40 not only firmly forces the nozzle against the manifold 20 but simultaneously it also secures by means of the centering/fixating elements the position of the nozzle 30 perpendicularly to the longitudinal axis A, whereby, following assembly, the manifold 20 and the nozzles 30 no longer may shift relative to one another. Moreover the fixating elements 50 operate in dualistic manner. The suppress on one hand any slippage between the manifold 20 and the nozzles 30 and simultaneously they constitute advantageously affixation elements for the fastener 40, as a result of which the manufacturing costs are kept low.

The continuous boreholes 27 in the manifold 20 and the recesses 41, 42 in the fastener 40 are configured in a manner that the nozzle 20 shall be forced against the underside 23 of the manifold 20 to ensure that the working material intake aperture 33 of the nozzle 30 always shall be configured concentrically with the working material outlet aperture 26 in the manifold 20. Accordingly the fixating elements 50 simultaneously constitute also centering elements for the hot runner nozzle 30.

In order to be able to rapidly and conveniently mount all nozzles 30 to the manifold 20, the fixating elements 50 resting in longitudinally displaceable manner in the fastener 40 need only be shifted behind the top side 40 of the barrel 43. In this manner a nozzle 30 inserted from above into the fastener 40 initially may be flatly configured against the lower side 23 of the manifold 20 while allowed to ignore the seats, the centering or fixating elements. Once all nozzles 30 are in position, the manifold plate 21 may be configured flatly on the nozzles 30, i.e. on the fasteners 40. The bolts 15 then being inserted into the continuous boreholes 27 enter from above the fixating elements 50 and pull them parallel to the longitudinal axis A through the fasteners 40 into the particular seats 29. In this manner the nozzles are sequentially fixated both axially and laterally.

To keep the centering/fixating elements 50 irrotational when the bolts 15 are screwed in, an omitted anti-rotation element is configured between the shank 52 and the additional recess 42 in the fastener 40. However such an anti-rotation element also may be configured between the flanged rim 54 and the fastener.

Also to preclude the fixating elements 50, when in their rearward position, from dropping out of the fastener 40, a stub-like segment 47 is constituted at the underside 44 of the barrel 43, this segment 47 at its end constituting a radially outward collar 46. Each fixating element 50 when in its unassembled state rests by its flange rim 54 on said collar 46. The distance H between the top side 45 of the fastener 40 and the collar 46 in this process is larger than the length I of the fixating element 50. The latter therefore always is situated behind the top side 45 of the fastener 40 before nozzle assembly. Also the collar 46 and the shell 47 are laterally flattened—as indicated in FIG. 2—in order that the total thickness d of the fastener 40 shall not exceed the total thickness D of the nozzle 30.

To allow inserting the fixating elements 50 in the wider recesses 42 in the fastener 40, the flanged rim 54 is laterally flattened, entailing two parallel keyed surfaces 55. When the fixating elements 50 are rotated in a manner that the keyed surfaces are situated in front of and across the collar 46, the bush 50 can be inserted with the shank 52 from below into the fastener 40. As soon as the flanged rim 54 has passed the collar 46, the keyed surfaces 55 are rotated by 90°. As a result the flanged rim 54 now is situated between the collar 46 and the lower side 44 of the fastener 40. The bush 50 is prevented from sliding out of the fastener 40 either at its top or at its bottom. The centering/fixating element 50 is connected in loss-proof manner to the fastener 40.

It follows that the longitudinal displacement of the fixating element 50 is limited. A first stop is constituted by the lower side 44 of the fastener 40 whereas the collar 46 constitutes a second stop for the fixating element 50.

To make inserting the fixating bush 50 into the seat 29 easier, said seat and/or the shank ends 56 of the shank 52 may be made slightly conical or may be fitted with gripping edges.

Two nozzle bodies are inserted into the fastener 40 in the embodiment mode of FIG. 4. The barrel-shaped main part 43 is correspondingly fitted with two recesses 41 for two connection heads 31 each merging into a narrow nozzle tube 32. A common heater 37 is mounted is mounted on said nozzle tube 32 and is fitted at its external side edges each with one heating element 38.

At its outer ends, the barrel 43 supports the centering/fixating elements 50 each of which is guided in the further recesses 42 and—as fixating nuts—jointly with the bolts 15 constituting the bolt connections 14. A borehole 48 with an inside thread 49 is configured in the fastener 40 between the recesses 41 for the connection heads 31 of the nozzles 30. Said inside thread is entered by another bolt 17 guided in another continuous borehole 27 in the manifold 20. The bolt 17 rests by its counter-sunk head 18 in the manifold 20 and in the process further tightens the fastener 40 against the lower side 23 of the manifold 20. This feature further raises the compression on the nozzles 30. The continuous boreholes 27, 27′ in the manifold and the recesses 42, 48 in the fastener preferably are symmetrical to the longitudinal axis A on a line in a manner that the outlet aperture 26 in the manifold 20 and the intake aperture 33 in the nozzle 33 always shall be congruently superposed and the nozzles 30 can be assembled subtending narrow cavity interspaces.

In this embodiment too it is important that the nozzle 30, the fastener 40 and the fixating elements 50 constitute a pre-assembled or pre-assemblable unit that initially shall be loaded into the mold 10 and that subsequently shall be sequentially fixed in position at the deposited manifold 20 and shall be centered.

The present invention is not restricted to one of the above embodiment modes but instead it may by modified in versatile manner. Illustratively, instead of a flat block heater 37, another kind of heater may be used, for instance a spiral heater. Latter as well, following deposition of the fasteners 40, may be rapidly and conveniently fastened to the nozzle tube 32. Also the injection molding apparatus 10 may be designed as a whole as a cold runner system. In that event the nozzle shall be a cold runner nozzle.

To secure the fixating elements 50 in the recesses 42, the fastener 40 may be fitted with—instead of a collar 48—a protrusion, a hook or the like which rearwardly engages the flanged rim 54 of the fixating elements 50. However pin guidance or a sort of bayonet guidance may also be used. It is critical that following their insertion into the recesses 42, the fixating elements 50 shall come to rest against a rearward stop to allow setting the nozzles 30 flat against the manifold 20. Only thereafter shall the bolts 15 engage the inside threads 53 of the irrotational fixating nuts 50 and draw these against the fastener 40. Where enough space is available, the fixating elements optionally may also be configured along a triangle or a circle around the longitudinal axis A of the nozzle 30.

To further enhance the compression of the nozzles 30 and to compensate for thermal length changes, the nozzles 30 may be spring loaded within the recess 41 of the fastener 40.

Preferably the nozzles 30 and the fastener 40 are manufactured separately. Where needed however they also may be made integrally.

All features and advantages, inclusive design details, spatial configurations and procedural steps, implicitly or explicitly stated, may be construed being inventive whether considered per se or in arbitrary combinations.

### LIST OF REFERENCES

A longitudinal axis
B width (nozzle)
D thickness (nozzle)
d thickness (fastener)
H height
l length
10 injection molding apparatus
14 bolt connection
15 bolt
16 head
17 bolt
18 head
20 manifold
21 manifold plate
22 top side
23 lower side
24 flow channel
26 outlet aperture
27 continuous borehole
27′ further continuous borehole
28 recess
29 seat
30 hot runner nozzle
31 connection head
32 tube
33 intake aperture
34 nozzle tip
35 outlet aperture
36 sealing ring
37 heating body
38 heating element
connection
39′ connection
40 fastener
41 recess
42 further recess
43 main part
44 lower side/first stop
45 top side
46 collar/second step
47 shell/segment
48 recess/borehole
49 inside thread
50 centering/fixating element/bush
52 shank
53 inside thread
54 flanged rim
55 keyed surface
56 shank ends

1. An injection molding apparatus (10) comprising at least one manifold (20) and at least one injection molding nozzle (30), each nozzle (30) being affixable by a fastener (40) to the manifold (20),
characterized in that the fastener (40) comprises at least one centering and/or fixating element (50) supported in longitudinally displaceable manner and in its end-mounted position is able to engage the manifold (20) in a manner that said manifold and the nozzle (30) are mutually fixed in position relative to each other.

2. Apparatus as claimed in claim 1, characterized in that the fastener (40) comprises at least one recess (41) to receive the nozzle (30).

3. Apparatus as claimed in claim 1, characterized in that the fastener (40) comprises at least one further recess (42) receiving the fixating element (50).

4. Apparatus as claimed in claim 1, characterized in that the fixating element (50) is supported in longitudinally displaceable manner in the further recess (42).

5. Apparatus as claimed in claim 1, characterized in that the fixating element (50) is configured parallel to, i.e. aligned with the longitudinal axis (A) of the nozzle (30).

6. Apparatus as claimed in claim 1, characterized in that the fixating element (50) can be mechanically interlocked with the manifold (20).

7. Apparatus as claimed in claim 1, characterized in that the fixating elements (50) is connected in loss-proof manner to the fastener (40).

8. Apparatus as claimed in claim 1, characterized in that the longitudinal excursion of the fixating element (50) is limited.

9. Apparatus as claimed in claim 9, characterized in that the lower side (44) of the fastener (40) constitutes a first stop for the fixating element (50).

10. Apparatus as claimed in claim 8, characterized in that the fastener (40) is fitted with a collar (46) with a protrusion, a hook or the like constituting a second stop for the fixating element (50).

11. Apparatus as claimed in claim 1, characterized in that the distance (H) between the top side (45) of the fastener (40) and the second stop (46) is larger than the length (I) of the fixating element (50).

12. Apparatus as claimed in claim 1, characterized in that the thickness (d) of the fastener (40) perpendicular to the longitudinal axis (A) and perpendicular to the width (B) of the nozzle (30) is less than or equal to the thickness (D) of said nozzle perpendicularly to the longitudinal axis (A) and perpendicular to the width (B).

13. Apparatus as claimed in claim 1, characterized in that the fixating element (50) is or constitutes an affixation element for the fastener (40).

14. Apparatus as claimed in claim 1, characterized in that the fixating element (50) is part of a bolt connection (14)

15. Apparatus as claimed in claim 14, characterized in that the bolt connection (14) passes through the manifold (20) and runs parallel to the longitudinal axis (A) of the nozzle (30).

16. Apparatus as claimed in claim 14, characterized in that the bolt connection (14) comprises at least one bolt (15) which can be made to engage the fixating element (50).

17. Apparatus as claimed in claim 14, characterized in that the fixating element (50) is supported irrotationally relative to the fastener (40).

18. Apparatus as claimed in claim 14, characterized in that the bolt connection (14) comprises at least one bolt (17) that can be made to engage the fastener (40).

19. Apparatus as claimed in claim 1, characterized in that the fixating element (50) is a bush having a cylindrical shell. (52) and a flanged rim (54) at one end.

20. Apparatus as claimed in claim 19, characterized in that the shell (52) is fitted with an inside thread (53).

21. Apparatus as claimed in claim 18, characterized in that the flanged rim (54) is laterally flattened by two mutually parallel, keyed surfaces (55).

22. Apparatus as claimed in claim 1, characterized in that at least two fixating elements (50) are used.

23. Apparatus as claimed in claim 22, characterized in that the fixating elements (50) are configured symmetrically to the longitudinal axis (A) of the nozzle (30).

24. Apparatus as claimed in claim 22, characterized in that the fixating elements (50) are configured as a triangle or a circle around the longitudinal axis (A) of the nozzle (30).

25. Apparatus as claimed in claim 1, characterized in that the fastener (40) receives at least two nozzles (30).

26. Apparatus as claimed in claim 1, characterized the nozzles (30) are fitted with a common heating element.

27. Apparatus as claimed in claim 1, characterized in that each nozzle (30) within the recess (41) of the fastener (40) is spring-loaded.

28. Apparatus as claimed in claim 1, characterized in that the nozzle (30), the fastener (40) and the fixating elements (50) constitute a pre-assembled or pre-assemblable unit.

29. Apparatus as claimed in claim 1, characterized in that the nozzle (30) and the fastener (40) are integral.
